(19) United States
(12) Patent Application Publication
(10) Pub. No.: US 2014/0172490 A1
(43) Pub. Date: Jun. 19, 2014

(54) SYSTEM, METHOD, AND APPARATUS FOR MANAGING AND PERFORMING GEOGRAPHICALLY DISTRIBUTED CELL-BASED MANUFACTURING AND/OR ASSEMBLY

(71) Applicant: David M. Snyder, Cedar Rapids, IA (US)

(72) Inventor: David M. Snyder, Cedar Rapids, IA (US)

(21) Appl. No.: 14/108,900

(22) Filed: Dec. 17, 2013

Related U.S. Application Data
(60) Provisional application No. 61/797,877, filed on Dec. 17, 2012.
(60) Provisional application No. 61/797,876, filed on Dec. 17, 2012.
(60) Provisional application No. 61/797,875, filed on Dec. 17, 2012.
(60) Provisional application No. 61/797,874, filed on Dec. 17, 2012.
(60) Provisional application No. 61/797,871, filed on Dec. 17, 2012.
(60) Provisional application No. 61/797,868, filed on Dec. 17, 2012.
(60) Provisional application No. 61/797,867, filed on Dec. 17, 2012.

(51) Int. Cl. G06Q 10/06

(52) U.S. Cl. CPC G06Q 10/06313
USPC 705/7.23

(57) ABSTRACT

The present invention relates in general to a computer implemented system, method, and apparatus for a geographically distributed, advanced cell-based manufacturing system, method, and apparatus that utilizes modular work benches and moveable parts racks. Also included are integrated computer hardware/software components, such as, machine code scanners, touch screens, barcode printers, PCs, tablets, communications capabilities, network gear, etc., in order to provide maximum flexibility, throughput, and profitability for various types of product mixes. This system increases profit margins by increasing inventory turns, reducing capitalization costs, and reducing hourly per square foot burden rates for production areas, and reducing non-productive management personnel, and by having the ability to place production equipment in near proximity to the end-user.

### CROSS-REFERENCE TO RELATED APPLICATIONS

This application claims priority to U.S. Provisional Application Ser. No. 61/797,877 filed Dec. 17, 2012 which is entitled SYSTEM, METHOD, AND APPARATUS NO. 1 FOR POWERING, CONTROLLING, AND COMMUNICATING WITH LED LIGHTS USING COMBINED LOW VOLTAGE POWER/DATA CABLING EXCLUDING ETHERNET WIRING.

This application claims priority to U.S. Provisional Application Ser. No. 61/797,876 filed Dec. 17, 2012 which is entitled SYSTEM, METHOD, AND APPARATUS NO. 3 FOR ISO 9001-OSHA CONTROLLED ERP SYSTEM.

This application claims priority to U.S. Provisional Application Ser. No. 61/797,875 filed Dec. 17, 2012 which is entitled SYSTEM, METHOD, AND APPARATUS NO. 5 FOR ISO 9001-OSHA CONTROLLED ERP SYSTEM.

This application claims priority to U.S. Provisional Application Ser. No. 61/797,874 filed Dec. 17, 2012 which is entitled SYSTEM, METHOD, AND APPARATUS NO. 2 FOR ISO 9001-OSHA CONTROLLED ERP SYSTEM.

This application claims priority to U.S. Provisional Application, Ser. No. 61/797,871 filed Dec. 17, 2012 which is entitled SYSTEM, METHOD, AND APPARATUS NO. 1 FOR ISO 9001-OSHA CONTROLLED ERP SYSTEM.

This application claims priority to U.S. Provisional Application Ser. No. 61/797,868 filed Dec. 17, 2012 which is entitled SYSTEM, METHOD, AND APPARATUS NO. 6 FOR ISO 9001-OSHA CONTROLLED ERP SYSTEM.

This application claims priority to U.S. Provisional Application Ser. No. 61/797,867 filed Dec. 17, 2012 which is entitled SYSTEM, METHOD, AND APPARATUS NO. 4 FOR ISO 9001-OSHA CONTROLLED ERP SYSTEM.

These aforementioned provisional applications are herein incorporated in their entirety by reference.

### FIELD OF INVENTION

The present invention relates in general to a computer implemented system, method, and apparatus for a geographically distributed, advanced cell-based manufacturing system, method, and apparatus that utilizes modular work benches and moveable parts racks. Also included are integrated computer hardware/software components, such as, machine code scanners, touch screens, barcode printers, PCs, tablets, communications capabilities, network gear, etc., in order to provide maximum flexibility, throughput, and profitability for various types of product mixes. This system increases profit margins by increasing inventory turns, reducing capitalization costs, and reducing hourly per square foot burden rates for production areas, and reducing non-productive management personnel, and by having the ability to place production equipment in near proximity to the end-user.

### BACKGROUND OF INVENTION

The inventors of the present invention specialize in Light Emitting Diode (LED) lighting product manufacturing and assembly. In addition, the inventors of the present invention also specialize in the development and use of high level management of systems needed to manufacture and/or assemble a mixture of LED products in widely dispersed geographic locations. These high level management systems include, but are not limited to, Information Technology (IT), Intellectual Property (IP), ISO 9001 Quality Systems and related audits, centralized purchasing, centralized materials management, centralized customer service, sales, and distribution.

What is needed is a computer implemented method, system, and apparatus for implementing a geographically distributed, cell-based manufacturing network that utilizes work benches and parts racks that include integrated computer hardware such as machine code scanners, touch screens, barcode printers, PCs, communications capabilities, network gear, etc., in order to provide maximum flexibility, throughput, and profitability for various types of product mixes.

### FEATURES AND OBJECTS OF THE PRESENT INVENTION

It is an object of the present invention to use a computer implemented method, system, and apparatus for a geographically distributed, cell-based manufacturing that utilizes work benches and parts racks that may include integrated computer hardware/software such as machine code scanners, touch screens, barcode printers, PCs, communications capabilities, network gear, etc., in order to provide maximum flexibility, throughput, and profitability for various types of product mixes.

It is an object of the present invention to provide for the use of 5s (Methodology).

It is an object of the present invention to provide for the use of Bills of Materials.

It is an object of the present invention to provide for the use of Change Management.

It is an object of the present invention to provide for the use of Constant WIP.

It is an object of the present invention to provide for the use of Continuous Flow Manufacturing.

It is an object of the present invention to provide for the use of Contract Manufacturing.

It is an object of the present invention to provide for the use of Corrective And Preventive Action.

It is an object of the present invention to provide for the use of Cycle Time.

It is an object of the present invention to provide for the use of Engineering Change. Notices.

It is an object of the present invention to provide for the use of Good Manufacturing Practices.

It is an object of the present invention to provide for the use of ISO 9000 Quality Management Systems

It is an object of the present invention to provide for the use of Just-in-time.

A still further object, feature, or advantage of the present invention is to provide for the use of an encapsulated HomePlug communication system protocol over a wired communication system.

A still further object, feature, or advantage of the present invention is to provide for the use of an encapsulated modem standard protocol such as, but not limited to Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56k (V.90), and Modem 56k (V.92) over a wire communication system.

A still further object, feature, or advantage of the present invention is to provide for the use of an encapsulated Integrated Services Digital Network (ISDN) based communication system protocol, such as, but not limited to 64k ISDN and 128k dual-channel ISDN over a wire communication system.

A still further object, feature, or advantage of the present invention is to provide for the use of an encapsulated computer interface protocol, such as, but not limited to Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMA ATA 33, Ultra Wide SCSI 40, FireWire (IEEE 1394) 400, USB Hi-Speed, Ultra DMAATA 66, Ultra-2 SCSI 80, FireWire (IEEE 1394b) 800, Ultra DMA ATA 100 800, Ultra DMA ATA 133, PCI 32/33, Serial ATA (SATA-150), Ultra-3 SCSI 160, Fibre Channel, PCI 64/33, PCI 32/66, AGP 1x, Serial ATA (SATA-300), Ultra-320 SCSI, PCI Express (x1 link), AGP 2x, PCI 64/66, Ultra-640 SCSI, AGP 4x, PCI-X 133, InfiniBand, PCI Express (x4 link), AGP 8x, PCI-X DDR, HyperTransport (800 MHz, 16-pair), PCI Express (x16 link), iSCSI (Internet SCSI), and HyperTransport (1 GHz, 16-pair) over a wire communications system.

A still further object, feature, or advantage of the present invention is to provide for the use of an encapsulated wireless communication based on standard protocols such as, but not limited to IrDA-Control, 802.15.4 (2.4 GHz), Bluetooth 1.1, 802.11 legacy, Bluetooth 2, RONJA free source optical wireless, 802.11b DSSS, 802.11b+non-standard DSSS, 802.11a, 802.11g DSSS, 802.11n, 802.16 (WiBro) and 802.16 (Hiperman) over a wire communications system.

A still further object, feature, or advantage of the present invention is to provide for the use of an encapsulated mobile telephone standards protocol, such as, but not limited to, GSM CSD, HSCSD, GPRS, and UMTS over a wire communications system.

A still further object, feature, or advantage of the present invention is to provide for the use of an encapsulated wide area network based system protocol, such as but not limited to, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2., OC3, OC12, OC48, OC192, 10 Gigabit Ethernet WAN PHY, 10 Gigabit Ethernet LAN PHY, OC256, and OC768 over a wire communications system.

A still further object, feature, or advantage of the present invention is to provide for the use of an encapsulated local area network protocol such as, but not limited to, LocalTalk, ARCNET, Token Ring, Ethernet (10 base-X), Fast Ethernet (100 base-X), FDDI, and Gigabit Ethernet (1000 base-X) over a wire communications system.

A still further object, feature, or advantage of the present invention is to provide for the use of an encapsulated VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny-Skinny Client Control Protocol (Cisco) over a wire communications system.

A still further object, feature, or advantage of the present invention is to provide for the use of an encapsulated VoIP (Voice over IP) standard media protocols, such as, but not limited to, DVB Digital Video Broadcasting, H.261 Video stream for transport using the real-time transport, H.263 Bitstream in the Real-time Transport Protocol, RTCP RTP Control protocol, and RTP Real-Time Transport over a wire communications system.

A still further object, feature, or advantage of the present invention is to provide for the use of encapsulated VoIP (Voice over IP) H.323 suite of standard protocols, such as, but not limited to, H.225 Covers narrow-band visual telephone services, H.225 Annex G H.225E H.235 Security and authentication H.323SET H.245 Negotiates channel usage and capabilities, H.450.1 Series defines Supplementary Services for H.323, H.450.2 Call Transfer supplementary service for H.323, H.450.3 Call diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy Subscribers supplementary service, H.450.10 Call Offer supplementary service, H.450.11 Call Intrusion supplementary service, H.450.12 ANF-CMN supplementary service, RAS Manages registration, admission, status, T.38 IP-based fax service maps, T.125 Multipoint Communication Service Protocol (MCS) over a wire communications system.

A still further object, feature, or advantage of the present invention is to provide for the use of encapsulated VoIP (Voice over IP) SIP suite of standard protocols, such as, but not limited to, MIME, SDP Session Description Protocol, and SIP Session Initiation Protocol over a wire communications system.

It is an object of the present invention of the present invention to use an XML schema known as AIML Markup Language, which is used for creating artificial intelligence chatterbots.

It is an object of the present invention of the present invention to use an XML schema known as Attention Profiling Markup Language (APML), which is a format for capturing a person's interests and dislikes.

It is an object of the present invention of the present invention to use an XML schema known as Atom, which is a language used for web feeds.

It is an object of the present invention of the present invention to use an XML schema known as Automated Test Markup Language (ATML), which defines a standard exchange medium for sharing data between components of automatic test systems.

It is an object of the present invention of the present invention to use an XML schema known as Attention.xml.

It is an object of the present invention of the present invention to use an XML schema known as aecXML, which is a Markup Language which uses Industry Foundation Classes to create a vendor-neutral means to access data generated by Building data Modeling.

It is an object of the present invention of the present invention to use an XML schema known as Binary Format Description Language, which is an extension of XSIL which has added conditionals and the ability to reference files by their stream numbers, rather than by their public URLs.

It is an object of the present invention of the present invention to use an XML schema known as Business Process Execution Language, which is a business process modeling language that is executable.

It is an object of the present invention of the present invention to use an XML schema known as Basic Markup Language, which is an easy to use Markup Language.

It is an object of the present invention of the present invention to use an XML schema known as Call Control eXtensible Markup Language, which is a standard designed to provide telephony support to VoiceXML.

It is an object of the present invention of the present invention to use an XML schema known as CellML, which is a language describing mathematical models.

It is an object of the present invention of the present invention to use an XML schema known as Channel Definition Format.

It is an object of the present invention of the present invention to use an XML schema known as Chemical Markup Language.

It is an object of the present invention of the present invention to use an XML schema known as CMRL, which is a Markup Language for concise message content. It is an object of the present invention of the present invention to use an XML schema known as COLLADA, which is standard for exchanging digital assets among various graphics software applications.

It is an object of the present invention of the present invention to use an XML schema known as Common Alerting Protocol (CAP).

It is an object of the present invention of the present invention to use an XML schema known as CXML, which is a protocol intended for communication of business documents between procurement applications, e-commerce hubs and suppliers.

It is an object of the present invention of the present invention to use an XML schema known as dicML for monolingual and bilingual dictionaries.

It is an object of the present invention of the present invention to use an XML schema known as Dimensional Markup Language.

It is an object of the present invention of the present invention to use an XML schema known as Directory Service Markup Language.

It is an object of the present invention of the present invention to use an XML schema known as DisplayML.

It is an object of the present invention of the present invention to use an XML schema known as Document Schema Definition Language.

It is an object of the present invention of the present invention to use an XML schema known as Document Structure Description, which is a schema language for XML.

It is an object of the present invention of the present invention to use an XML schema known as DotML.

It is an object of the present invention of the present invention to use an XML schema known as ebXML, which is a collection of Electronic Business specifications.

It is an object of the present invention of the present invention to use an XML schema known as EMML Enterprise Mashup Markup Language.

It is an object of the present invention of the present invention to use an XML schema known as ENML (eNotarization Markup Language).

It is an object of the present invention of the present invention to use an XML schema known as EPPML (Extensible Postal Product Model and Language).

It is an object of the present invention of the present invention to use an XML schema known as EPUB (electronic publication, open e-book format).

It is an object of the present invention of the present invention to use an XML schema known as Extensible Application Markup Language.

It is an object of the present invention of the present invention to use an XML schema known as Extensible Data Format.

It is an object of the present invention of the present invention to use an XML schema known as Extensible Messaging and Presence Protocol.

It is an object of the present invention of the present invention to use an XML schema known as Extensible Provisioning Protocol.

It is an object of the present invention of the present invention to use an XML schema known as Extensible Resource Identifier.

It is an object of the present invention of the present invention to use an XML schema known as Extensible Stylesheet Language.

It is an object of the present invention of the present invention to use an XML schema known as FDCML (Field Device Configuration Markup Language).

It is an object of the present invention of the present invention to use an XML schema known as FictionBook, which is an e-book format.

It is an object of the present invention of the present invention to use an XML schema known as FieldML (Field Modelling/Markup Language).

It is an object of the present invention of the present invention to use an XML schema known as FleXML, which is an XML transformation language.

It is an object of the present invention of the present invention to use an XML schema known as FpML, which is a Financial Products Markup Language.

It is an object of the present invention of the present invention to use an XML schema known as FreebXML.org, which is an initiative that aims to foster the development and object of the present invention of ebXML and related technology through software and experience sharing.

It is an object of the present invention of the present invention to use an XML schema known as FXT, which is a transformation specification for the Functional XML Transformation Tool.

It is an object of the present invention of the present invention to use an XML schema known as Geography Markup Language, which is a grammar defined by the Open Geospatial Consortium (OGC) to express geographical features.

It is an object of the present invention of the present invention to use an XML schema known as GPX, which is a language designed for transferring GPS data between software applications.

It is an object of the present invention of the present invention to use an XML schema known as GraphML, which is a standard exchange format for graphs.

It is an object of the present invention of the present invention to use an XML schema known as GuideML.

It is an object of the present invention of the present invention to use an XML schema known as GXA, which is an extension of SOAP being worked on by Microsoft, IBM and some other developers.

It is an object of the present invention of the present invention to use an XML schema known as GXL, which is a standard exchange format for graphs.

It is an object of the present invention of the present invention to use an XML schema known as Green Building XML, also known as “gbXML”, which is a schema to facilitate the transfer of building properties stored in 3D building data models (BIM) to engineering analysis tools, especially energy and building performance analysis.

It is an object of the present invention of the present invention to use an XML schema known as HelpML.

It is an object of the present invention of the present invention to use an XML schema known as HumanML, which is used for describing contextual (emotional, social, pragmatic) data about instances of human communication.

It is an object of the present invention of the present invention to use an XML schema known as data and Content Exchange.

It is an object of the present invention of the present invention to use an XML schema known as Industry Foundation Classes, which is specifically the “ifcXML” format, defined by ISO 10303-28 (“STEP-XML”), having file extension “.ifcXML”, which is suitable for interoperability with XML tools and exchanging partial building models.

It is an object of the present invention of the present invention to use an XML schema known as Interactive Media Markup Language, also known as IMML, which is used to define 3D spaces in the VastPark 3D platform.

It is an object of the present invention of the present invention to use an XML schema known as Java Speech Markup Language, which is a language for annotating text input to speech synthesizers.

It is an object of the present invention of the present invention to use an XML schema known as Job Definition Format, which is a standard developed by the graphic arts industry to facilitate cross-vendor work-flow implementations.

It is an object of the present invention of the present invention to use an XML schema known as Job Submission Description Language, which describes simple tasks to non-interactive computer execution systems.

It is an object of the present invention of the present invention to use an XML schema known as Keyhole Markup Language, which is used for geographic annotation.

It is an object of the present invention of the present invention to use an XML schema known as LandXML, which is a non-proprietary standard for data exchange among the land development, civil engineering and surveying communities.

It is an object of the present invention of the present invention to use an XML schema known as LGML, which is a Linguistics Markup Language, which is for describing natural languages.

It is an object of the present invention of the present invention to use an XML schema known as Link Contract.

It is an object of the present invention of the present invention to use an XML schema known as LOGML, also known as Log Markup Language, which is used for describing the log reports of web servers.

It is an object of the present invention of the present invention to use an XML schema known as Mail Markup Language (MML), which is a language describing and structuring content for email.

It is an object of the present invention of the present invention to use an XML schema known as MathML, which is a language describing mathematical notation.

It is an object of the present invention of the present invention to use an XML schema known as Microformats, which is a piece markup that allows expression of semantics in an HTML (or XHTML) web page.

It is an object of the present invention of the present invention to use an XML schema known as MOWL, which describes semantic interactions with multimedia content.

It is an object of the present invention of the present invention to use an XML schema known as MXML, which is a language used to declaratively lay-out the interface of applications, and also to implement complex business logic and rich Internet application behaviors.

It is an object of the present invention of the present invention to use an XML schema known as Namespace Routing Language.

It is an object of the present invention of the present invention to use an XML schema known as Namespace-based Validation Dispatching Language.

It is an object of the present invention of the present invention to use an XML schema known as National data Exchange Model.

It is an object of the present invention of the present invention to use an XML schema known as Nested Context Language.

It is an object of the present invention of the present invention to use an XML schema known as NeXML, which is an XML representation of the NeXus data format.

It is an object of the present invention of the present invention to use an XML schema known as NeuroML, which is a computational neuroscience model.

It is an object of the present invention of the present invention to use an XML schema known as ODD, also known as ‘One Document Does-it-all’ TEI format for simultaneously recording project documentation and meta-schema definition from which a person can generate RELAX NG, W3C XML Schema, and DTDs as well as formatted documentation.

It is an object of the present invention of the present invention to use an XML schema known as ODRL, which is an XML-based standard Rights Expression Language (REL) used in Digital Rights Management systems.

It is an object of the present invention of the present invention to use an XML schema known as Office Open XML, which is a Microsoft file format specification for the storage of electronic documents.

It is an object of the present invention of the present invention to use an XML schema known as OFX, also known as Open Financial Exchange, which is a unified specification for the electronic exchange of financial data between financial institutions, businesses and consumers via the Internet.

It is an object of the present invention of the present invention to use an XML schema known as Open Mathematical Documents (OMDoc), based on OpenMath and MathML, but with a greater coverage.

It is an object of the present invention of the present invention to use an XML schema known as OML, which is an XML format for outlines, based on OPML.

It is an object of the present invention of the present invention to use an XML schema known as Open eBook, which is the e-book format defined by Open eBook Publication Structure Specification; superseded by ePub.

It is an object of the present invention of the present invention to use an XML schema known as OpenDocument, which is a document file format used for describing electronic documents.

It is an object of the present invention of the present invention to use an XML schema known as OpenMath, which is a Markup Language for mathematical formulas which can complement MathML.

It is an object of the present invention of the present invention to use an XML schema known as OPML, which is an XML format for outlines.

It is an object of the present invention of the present invention to use an XML schema known as PMML, which an XML Markup Language for predictive analytics and data mining.

It is an object of the present invention of the present invention to use an XML schema known as RailML, which is a Markup Language for interoperability in railway industry applications.

It is an object of the present invention of the present invention to use an XML schema known as RAML, which is a vocabulary for describing relational algebra expressions.

It is an object of the present invention of the present invention to use an XML schema known as RDFa.

It is an object of the present invention of the present invention to use an XML schema known as Regular Language.

It is an object of the present invention of the present invention to use an XML schema known as RELAXNG.

It is an object of the present invention of the present invention to use an XML schema known as Resource Description Framework (RDF), which is a meta-data model based upon the idea of making statements about resources.

It is an object of the present invention of the present invention to use an XML schema known as RSS.

It is an object of the present invention of the present invention to use an XML schema known as RSS enclosure.

It is an object of the present invention of the present invention to use an XML schema known as S5 file format, which describes slide-show data.

It is an object of the present invention of the present invention to use an XML schema known as SAML, which is used for authentication and authorization data.

It is an object of the present invention of the present invention to use an XML schema known as Scalable Vector Graphics, which describes two-dimensional vector graphics.

It is an object of the present invention of the present invention to use an XML schema known as SCORM, which is a Markup Language for web-based e-learning.

It is an object of the present invention of the present invention to use an XML schema known as Shopinfo.xml, which is used to provide shop and product data.

It is an object of the present invention of the present invention to use an XML schema known as Simple Sharing Extensions.

It is an object of the present invention of the present invention to use an XML schema known as SOAP, which is a protocol for exchanging XML-based messages over computer networks.

It is an object of the present invention of the present invention to use an XML schema known as SOAP with Attachments, which describes the method of using Web Services to send and receive files using a combination of SOAP and MIME, primarily over HTTP.

It is an object of the present invention of the present invention to use an XML schema known as Speech Application Language Tags.

It is an object of the present invention of the present invention to use an XML schema known as Speech.

It is an object of the present invention of the present invention to use an XML schema known as Synthesis Markup Language, which is a Markup Language for speech synthesis applications.

It is an object of the present invention of the present invention to use an XML schema known as SPML, which provides a user, resource and service provisioning data.

It is an object of the present invention of the present invention to use an XML schema known as StratML, which is an XML vocabulary and schema for strategic plans.

It is an object of the present invention of the present invention to use an XML schema known as Streaming Transformations for XML, which is a XML transformation language intended as a high-speed, low memory consumption alternative to XSLT.

It is an object of the present invention of the present invention to use an XML schema known as SXBL, which defines the presentation and interactive behavior of elements described in SVG.

It is an object of the present invention of the present invention to use an XML schema known as Synchronized Multimedia Integration Language, which describes multimedia presentations.

It is an object of the present invention of the present invention to use an XML schema known as Text Encoding Initiative, which describes guidelines for text encoding, with schemas and a mechanism to customize to individual project needs.

It is an object of the present invention of the present invention to use an XML schema known as ThML, also known as Theological Markup Language, created by Christian Classics Ethereal Library (CCEL), to create electronic theological texts.

It is an object of the present invention of the present invention to use an XML schema known as Topicmaps.

It is an object of the present invention of the present invention to use an XML schema known as TransducerML, which is an Open Geospatial Consortium language for describing sensors and their output.

It is an object of the present invention of the present invention to use an XML schema known as Translation Memory eXchange (TMX), which is describes translation memory data.

It is an object of the present invention of the present invention to use an XML schema known as TREX, which is a simple schema language.

It is an object of the present invention of the present invention to use an XML schema known as Twitter Markup Language (TML), which is a subset of RTML.

It is an object of the present invention of the present invention to use an XML schema known as Universal Description Discovery and Integration (UDDI), which describes a registry for businesses worldwide to list themselves on the Internet.

It is an object of the present invention of the present invention to use an XML schema known as Vector Markup Language, which is used to produce vector graphics, implemented in Microsoft Office 2000 and higher.

It is an object of the present invention of the present invention to use an XML schema known as It is an object of the present invention of the present invention to use an XML schema known as Vexi, which is an easy-to-use platform for the development and delivery of Internet application interfaces.

It is an object of the present invention of the present invention to use an XML schema known as Video Ad Serving Template VAST, which is an IAB sponsored language for use in delivery of inline/linear and non-linear video advertising online.

It is an object of the present invention of the present invention to use an XML schema known as VoiceXML, which describes a format for specifying interactive voice dialogues between a human and a computer.

It is an object of the present invention of the present invention to use an XML schema known as W3C MMI.

It is an object of the present invention of the present invention to use an XML schema known as WDDX, also known as Web Distributed Data eXchange.

It is an object of the present invention of the present invention to use an XML schema known as Web Feed.

It is an object of the present invention of the present invention to use an XML schema known as Web Ontology Language, which is a Markup Language for defining and instantiating Web ontologies (a set of concepts within a domain and the relationships between those concepts).

It is an object of the present invention of the present invention to use an XML schema known as Web Services Description Language, which is an XML-based language that provides a model for describing Web services.

It is an object of the present invention of the present invention to use an XML schema known as Web Services Dynamic Discovery, which is a technical specification that defines a multicast discovery protocol to locate services on a local network.

It is an object of the present invention of the present invention to use an XML schema known as WML, also known as Wireless Markup Language.

It is an object of the present invention of the present invention to use an XML schema known as WiX, also known as Windows Installers Data.

It is an object of the present invention of the present invention to use an XML schema known as WordprocessingML, which is a file format specification for the storage of electronic documents.

It is an object of the present invention of the present invention to use an XML schema known as WS-Policy.

It is an object of the present invention of the present invention to use an XML schema known as X3D, also known as Extensible 3D, which is an international standard for real-time 3D computer graphics, the successor to Virtual Reality Modeling Language (VRML).

It is an object of the present invention of the present invention to use an XML schema known as XAML, which is a declarative XML-based vector graphics Markup Language.

It is an object of the present invention of the present invention to use an XML schema known as XACML, also known as eXtensible Access Control Markup Language.

It is an object of the present invention of the present invention to use an XML schema known as XBEL, which is also known as XML Bookmark Exchange Language.

It is an object of the present invention of the present invention to use an XML schema known as XBL, which is used to declare the behavior and look of ‘XUL’-widgets XML elements.

It is an object of the present invention of the present invention to use an XML schema known as XBRL, which is an open data standard for financial reporting.

It is an object of the present invention of the present invention to use an XML schema known as xCBL, which is a collection of XML specifications for use in e-business. It is an object of the present invention of the present invention to use an XML schema known as xCal, which is the XML-compliant representation of the iCalendar standard.

It is an object of the present invention of the present invention to use an XML schema known as XCES, which is an XML based standard to codify text corpus.

It is an object of the present invention of the present invention to use an XML schema known as XDI, which is used for sharing, linking, and synchronizing data using machine-readable structured documents that use an RDF vocabulary based on XRI structured identifiers.

It is an object of the present invention of the present invention to use an XML schema known as Xduce, which is an XML transformation language.

It is an object of the present invention of the present invention to use an XML schema known as XDXF, which is used for monolingual and bilingual dictionaries.

It is an object of the present invention of the present invention to use an XML schema known as XFA, which enhances the processing of web forms.

It is an object of the present invention of the present invention to use an XML schema known as Xforms, which is a format for the specification of a data processing model for XML data and user interface(s) for the XML data, such as web forms.

It is an object of the present invention of the present invention to use an XML schema known as XHTML, which is a Markup Language that has the same depth of expression as HTML, but with a syntax conforming to XML.

It is an object of the present invention of the present invention to use an XML schema known as XHTML Basic.

It is an object of the present invention of the present invention to use an XML schema known as XHTML Friends Network.

It is an object of the present invention of the present invention to use an XML schema known as XHTML Modularization.

It is an object of the present invention of the present invention to use an XML schema known as XidML, which is an open standard used within the flight test instrumentation industry that describes instrumentation and how data is acquired, stored, transmitted and processed.

It is an object of the present invention of the present invention to use an XML schema known as Xinclude, which describes a processing model and syntax for general purpose XML inclusion.

It is an object of the present invention of the present invention to use an XML schema known as XLIFF, which is a XML Localization Interchange File Format, a format created to standardize localization.

It is an object of the present invention of the present invention to use an XML schema known as Xlink, which is a language used for creating hyperlinks in XML documents.

It is an object of the present invention of the present invention to use an XML schema known as XMI, which is an OMG standard for exchanging meta-data data via XML, which is the most common use of XMI is as an interchange format for UML models.

It is an object of the present invention of the present invention to use an XML schema known as XML Encryption, which is a specification that defines how to encrypt the content of an XML element.

It is an object of the present invention of the present invention to use an XML schema known as XML data Set, which describes an abstract data model of an XML document in terms of a set of data items.

It is an object of the present invention of the present invention to use an XML schema known as XML Interface for Network Services, which is the definition and implementation of Internet applications, enforcing a specification-oriented approach.

It is an object of the present invention of the present invention to use an XML schema known as XML Resource, which provides a platform independent way of describing windows in a GUI.

It is an object of the present invention of the present invention to use an XML schema known as XML Schema, which is a description of a type of XML document, typically expressed in terms of constraints on the structure and content of documents of that type, above and beyond the basic syntax constraints imposed by XML itself.

It is an object of the present invention of the present invention to use an XML schema known as XML Script, which is a XML transformation language, or a Microsoft technology preview for scripting web browsers.

It is an object of the present invention of the present invention to use an XML schema known as XML Signature, which is an XML syntax for digital signatures.

It is an object of the present invention of the present invention to use an XML schema known as XML for Analysis, which is used to provide data access in analytical systems, such as OLAP and Data Mining.

It is an object of the present invention of the present invention to use an XML schema known as XML pipeline: a language expressing how XML transformations are connected together.

It is an object of the present invention of the present invention to use an XML schema known as XML-RPC, which is a remote procedure call protocol which uses XML to encode its calls and HTTP as a transport mechanism.

It is an object of the present invention of the present invention to use an XML schema known as XMLmosaic, which is a programming language contained in XML code. The XML describes relationships between classes and contains the procedures.

It is an object of the present invention of the present invention to use an XML schema known as XMLTerm, which is a Mozilla-based Semantic User Interface.

It is an object of the present invention of the present invention to use an XML schema known as XMLTV, which is a format to represent TV listings.

It is an object of the present invention of the present invention to use an XML schema known as XMLVM, which is a format used to convert java .class files and .NET .exe files into other languages such as JavaScript or Objective-C.

It is an object of the present invention of the present invention to use an XML schema known as XOMGL, which is used to obtain large amounts of data from municipal government agencies.

It is an object of the present invention of the present invention to use an XML schema known as XOXO, which is an XML microformat for publishing outlines, lists, and blogrolls on the Web.

It is an object of the present invention of the present invention to use an XML schema known as XPDL, also known as Interchange Business Process, which describes definitions between different workflow products.

It is an object of the present invention of the present invention to use an XML schema known as XPath (or XPath 1.0).

It is an object of the present invention of the present invention to use an XML schema known as XPath 2.0, which is a language for addressing portions of XML documents, successor of XPath 1.0.

It is an object of the present invention of the present invention to use an XML schema known as Xpointer, which is a language used for addressing components of XML based Internet media.

It is an object of the present invention of the present invention to use an XML schema known as Xproc, which is a W3C standard language to describe XML Pipeline.

It is an object of the present invention of the present invention to use an XML schema known as Xquery, which is a query language designed to query collections of XML data (similar to SQL).

It is an object of the present invention of the present invention to use an XML schema known as XrML, also known as the eXtensible Rights Markup Language, or the Rights Expression Language (REL) for MPEG-21.

It is an object of the present invention of the present invention to use an XML schema known as Xrules, which is a rules language that expresses constraints, calculations, inter-dependencies, and properties that describe and exist among elements and attributes of an XML document.

It is an object of the present invention of the present invention to use an XML schema known as XSIL, which is an XML-based transport language for scientific data.

It is an object of the present invention of the present invention to use an XML schema known as XSL Formatting Objects, which is a Markup Language for XML document formatting which is most often used to generate PDFs.

It is an object of the present invention of the present invention to use an XML schema known as XSL Transformations, which is a language used for the transformation of XML documents.

It is an object of the present invention of the present invention to use an XML schema known as XSPF, which describes a play-list format for digital media.

It is an object of the present invention of the present invention to use an XML schema known as XUL, which is a XML user interface Markup Language developed by the Mozilla project.

It is an object of the present invention of the present invention to use an XML schema known as Xupdate, which is a lightweight query language for modifying XML data. It is an object of the present invention of the present invention to use a proprietary XML schema.

It is an object of the present invention of the present invention to use the technology known as the Semantic Web.

It is an object of the present invention of the present invention to use a technology known as HTML 5.0.

It is an object of the present invention to use Drupal technology.

### BRIEF DESCRIPTION OF THE FIGURES

FIG. 1 is an illustration of the work cells used in the present invention.

FIG. 2 is an illustration of the high level network architecture of the present invention.

### SUMMARY OF INVENTION

The present invention relates specifically to a geographically distributed, cell-based manufacturing system, method, and apparatus that utilizes work benches and parts racks that may include integrated computer hardware such as machine code scanners, touch screens, barcode printers, PCs, communications capabilities, network gear, etc., in order to provide maximum flexibility, throughput, and profitability for various types of product mixes.

The present invention is a distributed cellular manufacturing system.

The distributed cellular manufacturing system is controlled by an integrated ISO 9001 Quality/OSHA Rules-Based System that controls an Enterprise Resource Planning (ERP) System.

The present invention is the logical product of years of practicing lean manufacturing by the founders of Vertecra work in the engineering, manufacturing, and quality organizations in various automotive and heavy metal industries.

The present invention is NOT actually cellular based manufacturing, as it does not rely on the breakdown of complicated processes into cooperative cells.

The present invention is NOT an assembly line either, as the entire assembly process occurs at a work station (a cell) that is fully optimized for any particular product.

Products that fit into the present invention system are typically capable of being assembled by one or two moderately skilled persons at a rate that is acceptable as compared to the final cost and selling price.

LED (Light Emitting Diode) lights are only one example of a product that can produce high-margins by taking advantage of a highly advantageous amortization schedule vs. what must be accounted for when setting-up multi-million dollar, robotic assembly lines in highly purposed factories, 2) by leveraging extremely low burden rates per hour per square foot vs. a typical factory, 3) by creating a lean environment for workers to self-schedule within work groups using the concept of micro-shifts, which keeps productivity rates at the highest levels, 4) by building to order and not to stock, 5) by achieving incredibly high inventory turns for components, 6) by using a supplier's warehouse combined with a Just In Time (J.I.T.) delivery system to keep non-productive floor space requirements to a minimum, 7) by creating an on-the-fly, flexible manufacturing system that does not need to off-line specials, 8) by producing in a geographical area that is very close to the end user, 9) by trading the location of a centrally located high-purposed factory vs. the location of centrally located vendors to the quality auditing source to dramatically increase the frequency of contact with the critical vendor base, which results in an increase in overall quality, 10) all parts and sub-components are ordered and packaged by vendors in pre-matched Kanban quantities, and 11) traditional factories and manufacturing processes are concerned with reduced changeover times in order to increase up-time on expensive production equipment, in the present invention, we are not overly concerned with expending large sums of money to achieve rapid changeovers because we have gained a large monetary advantage through lower burden rates, smaller capital outlays, and more advantageous amortization schedules, etc.

The present invention can be used in more esoteric ways in conjunction with micro-economics to create brand new economic opportunities by a wide variety of willing entrepreneurs, disadvantaged persons, and various organizations and companies within the boundaries of local neighborhoods. The present invention unlocks money hidden in the burden, amortization, and operation of factories that normal lean manufacturing practices cannot free up.

The off-the-shelf Enterprise Resource Planning (ERP) software's supply chain and manufacturing fulfillment logic is modified extensibly to include integrated business modules for projects (orders) from pre-sales, to sales, to customer premise audits, to sales engineering activities, and also through the project management cycle of all field activities. In other-words, the underlying ERP supply chain management system is modified to include non-supply chain management activities that occur before and after the primary manufacturing fulfillment modules that comprise standard ERP logic and processes, such as, procurement, route sheets, etc.

The ISO 9001/OSHA Rules-Based business and process logic is programmed into control layer web screens, and the underlying ERP/Project Management system feed an intermediate series of databases, which in turn feed the ISO 9001/OSHA Rules-Based business logic and process screens. In this way, ERP systems can easily be substituted if the need arises. The ISO 9001/OSHA Rules-Based control layer also includes log-on, VPN controls, time-clock, tasks, messaging, and other functions for all users of the system.

The ISO 9001/OSHA Rules-Based control layers are driven by projects (orders), and dashboards to give account executives, management personnel, engineering, and project managers quick visual representations of work that needs to be completed in order to drive a specific project (order) through the system from pre-sales to procurement to manufacturing to installation by a qualified contractor to custody, control, and disposal of old product and to follow-up validation.

### EXEMPLARY EMBODIMENT OF THE PRESENT INVENTION

The present invention relates specifically to a geographically distributed, cell-based manufacturing system, method, and apparatus that utilizes work benches and parts racks that may include integrated computer hardware such as machine code scanners, touch screens, barcode printers, PCs, communications capabilities, network gear, etc., in order to provide maximum flexibility, throughput, and profitability for various types of product mixes.

Traditional implementations of cellular manufacturing are a model for workplace design, and has become an integral part of lean manufacturing systems. Traditional cellular manufacturing is based upon the principals of Group Technology, which seeks to take full advantage of the similarity between parts, through standardization and common processing. In Functional Manufacturing, similar machines are placed close together (e.g. lathes, millers, drills, etc.). Functional layouts are more robust to machine breakdowns, have common jigs and fixtures in the same area and supports high levels of demarcation. In traditional cellular manufacturing systems machines are grouped together according to the families of parts produced. The major advantage is that material flow is significantly improved, which reduces the distance traveled by materials, inventory and cumulative lead times. Traditional cellular manufacturing employs setup reduction and gives the workers the tools to be multi-process, operating multiple processes, and multifunctional, owning quality improvements, waste reduction, and simple machine maintenance. This allows workers to easily self-balance within the cell while reducing lead times, resulting in the ability for companies to manufacture high quality products at a low cost, on time, and in a flexible way. The present invention uses the basic concepts of traditional cellular manufacturing, that workers are multifunctional in that they assemble entire products at their assembly cells, but can assemble multiple different products per shift. The present invention is designed for workers to perform work orders for a quantity of at least one for an entire assembly. The present invention can be viewed as a complete assembly line within an assembly cell.

The goal of traditional lean manufacturing is the aggressive minimization of waste, called muda, to achieve maximum efficiency of resources. Traditional cellular manufacturing, sometimes called cellular or cell production, arranges factory floor labor into semi-autonomous and multi-skilled teams, or work cells, who manufacture complete products or complex components. Properly trained and implemented cells are more flexible and responsive than the traditional mass-production line, and can manage processes, defects, scheduling, equipment maintenance, and other manufacturing issues more efficiently. In the present invention, the work team is comprised of one worker. Kitters and material handlers provide an in-house service to at least one assembly cell worker, but in the present invention, each assembly cell worker is a human resource for end-to-end assembling, packaging, labeling, and reporting.

The goal of traditional cellular manufacturing is having the flexibility to produce a high variety of low demand products, while maintaining the high productivity of large scale production. The goal of the present invention's cellular-based manufacturing innovation is providing the flexibility needed to produce a random mix of products according to demands placed on the system by sales and marketing. High demand and/or low demand products that are completed end-to-end from individual components, are sub-assemblies or final assembled product that is packaged, labeled, and reported as a completed SKU to the IT management system within an individual assembly cell. Traditionally, cell designers achieve this through modularity in both process design and product design. The present invention does not required modularity in product design. Traditional cellular processes are arranged in a U-shape so that the beginning and end of the material flow within the assembly cell are near each other. This allows quick re-balancing of tasks without redesigning stations, because workers can cross the aisle. The present invention is a small foot-print cell, and the process begins at one end of the short length assembly cell, and is completed through packaging, labeling, and reporting at the other end of the short length assembly cell.

The division of the entire production process into discrete segments, and the assignment of each segment to a work cell, introduces the modularity of processes. The present invention takes non-complicated products, and breaks down the entire production process into a system, method, and apparatus that is designed to operate on work orders of quantities of at least one. In the present invention, cell processes are designed to be implemented in small or large foot-print facilities for a high variety of high-value LED lighting products assembled in widely dispersed locations. These method of adjusting the throughput to the requirement for flexibility for any size facility foot-print provides maximum profitability in many ways. The burdened rate of a 10,000 SF facility operating eight of the present invention's assembly cells cannot be matched in a 300,000 SF facility operating 250 assembly cells. The assembly cells used in the present invention may have no conveyor movement of parts between machines, or they may have a flow line connected by a conveyor that can provide automatic transfer. Alternatively, parts and materials can be brought to the assembly cell on human-powered rolling carts and racks. In addition, material handling equipment, such as a forklift, can be used to convey parts and materials to the assembly cells, and finished goods away from assembly cells.

In traditional cellular based manufacturing, product modularity must match the modularity of processes. Even though the entire production system becomes more flexible, each individual cell is still optimized for a relatively narrow range of tasks, in order to take advantage of the mass-production efficiencies of specialization and scale. In the present invention, each individual assembly cell is optimized using a wide range of tasks, in order to match production work orders to sales orders one-to-one.

In traditional cellular manufacturing, to the extent that a large variety of products can be designed to be assembled from a small number of modular parts, both high product variety and high productivity can be achieved. When the finished product is of sufficiently high value and high margin, the modularity of parts becomes less important, than the modularity of the individual assembly cell to be the ultimate point of flexibility within the system. That being said, it is important for some modularity to exist within a product line in order to reduce the total number of individual part and sub-assembly SKUs needed to build the widest variety of similar products. For example, a varied range of automobiles may be designed to use the same chassis, a small number of engine configurations, and a moderate variety of car bodies, each available in a range of colors. In this way, a large variety of automobiles, with different performances and appearances and functions, can be produced by combining the outputs from a more limited number of assembly cells.

Traditionally, in cell-based manufacturing, each modular part is designed for a particular work cell, or dedicated clusters of machines or manufacturing processes. Cells are usually bigger than typical conventional workstations, but smaller than a complete conventional department. Within the present invention, each individual assembly cell is modular in the sense that a wide variety of similar, or non-similar products can be produced within the physical constraints of the assembly cell.

In traditional cellular manufacturing, each cell is responsible for its own internal control of quality, scheduling, ordering, and record keeping. The idea is to place the responsibility of these tasks on those who are most familiar with the situation and most able to quickly fix any problems. The middle management no longer has to monitor the outputs and inter-relationships of every single worker, and instead only has to monitor a smaller number of work cells and the flow of materials between them, often achieved using a system of kanbans. Within the present invention, each cell is one assembly cell, not a collection of assembly cells. Each individual assembly cell within the present invention is responsible for internal control of quality and record keeping. Ordering is accomplished by kanbans, and scheduling is controlled by an IT system that drives the assembly work through at least one assembly cell for end-to-end work orders from a collection of individual parts to a finished product assembly that is packaged, labeled, and reported to the IT system, in which the work order is a quantity of at least one.

The biggest challenge in traditional cellular manufacturing is dividing the entire manufacturing system into cells. The issues may be conceptually divided in the “hard” issues of equipment, such as material flow and layout, and the “soft” issues of management, such as up-skilling and corporate culture. Within the present invention, the individual assembly cells are autonomous, and the kitters and material handlers merely provide an in-house service to at least one assembly cell in which both the assembly cell, and the kitters and materials handlers are responding to the IT manufacturing management system that is organizing work orders according to actual sales orders entered into the system.

Within a traditional cellular manufacturing system, product start-ups can be more difficult to manage if assembly training was traditionally accomplished station-by-station on a fixed assembly line. As each operator in a cell is responsible for a larger number of assembled parts and operations, the time needed to master the sequence and techniques is considerably longer. If multiple parallel cells are used, each cell must be launched separately (meaning slower production ramp) or with equal training resources (meaning more in total). The consideration of the cell's internal group dynamics, personalities and other traits is often more of a concern in cellular manufacturing due to the closer proximity and co-dependency of the team members; however properly implemented this is a major benefit of cellular manufacturing. Within the present invention, each worker's assembly cell includes a computer implemented hardware/software system in which complicated ERP requirements, complicated ISO work instructions, and complicated reporting requirements are made uncomplicated through the use of touch screens that are icon driven in order to un-complicate the path to needed information. The present invention takes a lesson from the mobile app world in which complicated keyboard strokes and mouse movements are simplified to a mere icon in order to launch an application, or sub-application. Within the present invention, touching a touch screen icon might launch and validate a VPN connection, and bring up a written ISO instruction, or a video work assembly instruction for a particular part of a process for a particular product being assembled within the assembly work cell. Another icon on a touch screen at an assembly cell can launch a VPN as needed, and initiate a verbal and/or visual and/or audio instruction for a part of the process for a particular product being assembled within the assembly work cell. Even another icon can be used to generate labeling, and a reporting function for the finished product that was assembled within the assembly work cell.

XML is an important technology that can optionally be employed within the present invention. As an example, with the use of XML, any variety of languages is instantly available to be translated without manual interference.

RFID can potentially be used in many applications within the present invention. A tag can be affixed to any object and used to track and manage inventory, assets, people, etc. For example, it can be affixed to cars, computer equipment, books, mobile phones, etc. The Healthcare industry has used RFID to reduce counting, looking for things and auditing items. Many financial institutions use RFID to track key assets and automate compliance. Also with recent advances in social media RFID is being used to tie the physical world with the virtual world. RFID in Social Media first came to light in 2010 with Facebook's annual conference.

RFID is a superior and more efficient way of identifying objects than manual system or use of barcode systems that have been in use since the 1970s. Furthermore, passive RFID tags (those without a battery) can be read if passed within close enough proximity to an RFID reader. It is not necessary to “show” the tag to the reader device, as with a barcode. In other words it does not require line of sight to “see” an RFID tag, the tag can be read inside a case, carton, box or other container, and unlike barcodes RFID tags can be read hundreds at a time. barcodes can only be read one at a time.

EPCglobal standards are very important, and can be used within the present invention for encoding and formatting the Electronic Product Code (EPC) apply to both RFID tags, and barcode labels.

A barcode is an optical machine-readable representation of data, which shows data about the object to which it is attached. Originally, barcodes represented data by varying the widths and spacings of parallel lines, and may be referred to as linear or 1 dimensional (1D). Later they evolved into rectangles, dots, hexagons and other geometric patterns in 2 dimensions (2D). Although 2D systems use a variety of symbols, they are generally referred to as barcodes as well. Barcodes originally were scanned by special optical scanners called barcode readers; later, scanners and interpretive software became available on devices including desktop printers and smartphones.

The machine-readable code data used within the present invention, may contain ID numbers, serials numbers, work order numbers, date and time information, etc., based upon the application. In addition, other items can be contained within the machine-readable code such as, but not limited to a bar code representation including data such as, but not limited to, lot numbers, location information, control numbers, etc. The format for the bar code can include 1D or 2D protocols, such as, but not limited to Code 39 extended, Danish PTT 39 machine-readable code, French Postal 39 A/R, German Postal machine-readable code, Identcode 11, German Postal machine-readable code, Leitcode 13, 2 of 5 Industrial, 2 of 5 Matrix Plessey, Codabar, MSI Plessey, MSI Plessey+CHK10, MSI Plessey+CHK10+CHK10, MSI Plessey+CHK11+CHK10, 2 of 5 IATA, 2 of 5 Datalogic, Code 39 Reduced, USPS tray label, USPS sack label, Code32, Codabar Rationalised, MSI Plessey+CHK11, OMR, Code 93, Code 93 extended, 128 A, 128 B, 128 C, UCC-128, EAN/JAN-8, EAN/JAN-8+2, EAN/JAN-8+5, EAN/JAN-13, EAN/JAN-13+2, EAN/JAN-13+5, UPC-A, UPC-A+2, UPC-A+5, UPC-E, UPC-E+2, UPC-E+5, Oc UNICODE, 128 autoswitch, EAN 128, ISBN, ISSN, Swiss Postal, Code11, UPS Standard (18 digits), UPS 18 digits, UPS Standard (11 digits), UPS 11 digits, 128.times. (Free Type), Telepen, PDF-417, PDF-417 (HP Mode), MicroPDF417, Royal Mail 4-State Customer Code, Dutch 4-State Postal, Singapore Post 4-State Postal Code, Australia Post 4-State Postal Code, Japan Post 4-State Postal Code, Australia Post 4-State Postal Code 37, 52, 67, Australia 4-state postal 37-CUST (HP Mode), Australia 4-state postal 52-FF-MET (HP Mode), Australia 4-state postal 67-FF-MET (HP Mode), Australia 4-state postal FCC-45 REPLY (HP Mode), Singapore Post 4-State Postal Code (HP Mode), DataMatrix, MaxiCode, MaxiCode (HP Mode), USPS FIM, POSTNET 5 ZIP+4, POSTNET 9 ZIP+4, POSTNET 11 DPC, PLANET, Aztec, Aztec Mesas, QR Code, Code 49, Channel Code, Code One, SuperCode, RSS, EAN/UCC Composite Symbology, Codablock F, Dot Code A, Code16K, and EPCglobal formatted machine readable code, etc.

Electronic data interchange (EDI) is an important technology that can used with the present invention for the structured transmission of data between organizations by electronic means. It is used to transfer electronic documents or business data from one computer system to another computer system, as an example, from one trading partner to another trading partner without human intervention.

It is more than mere e-mail; for instance, organizations might replace bills of lading and even checks with appropriate EDI messages. It also refers specifically to a family of standards.

In 1996, the National Institute of Standards and Technology defined electronic data interchange as “the computer-to-computer interchange of strictly formatted messages that represent documents other than monetary instruments. EDI implies a sequence of messages between two parties, either of whom may serve as originator or recipient. The formatted data representing the documents may be transmitted from originator to recipient via telecommunications or physically transported on electronic storage media.” It distinguishes mere electronic communication or data exchange, specifying that in EDI, the usual processing of received messages is by computer only. Human intervention in the processing of a received message is typically intended only for error conditions, for quality review, and for special situations. For example, the transmission of binary or textual data is not EDI as defined here unless the data are treated as one or more data elements of an EDI message and are not normally intended for human interpretation as part of online data processing.

EDI can be formally defined as the transfer of structured data, by agreed message standards, from one computer system to another without human intervention.

EDI is considered to be a technical representation of a business conversation between two entities, either internal or external. Note that there is a perception that “EDI” constitutes the entire electronic data interchange paradigm, including the transmission, message flow, document format, and software used to interpret the documents. EDI is considered to describe the rigorously standardized format of electronic documents. EDI is very useful in supply chain.

The EDI standards were designed to be independent of communication and software technologies. EDI can be transmitted using any methodology agreed to by the sender and recipient. a person's includes a variety of technologies, including modem (asynchronous and synchronous), FTP, e-mail, HTTP, AS1, AS2, etc. It is important to differentiate between the EDI documents and the methods for transmitting them. When they compared the synchronous protocol 2400 bit/s modems, CLEO devices, and value-added networks used to transmit EDI documents to transmitting via the Internet, some people equated the non-Internet technologies with EDI and predicted erroneously that EDI itself would be replaced along with the non-Internet technologies. These non-Internet transmission methods are being replaced by Internet protocols such as FTP, telnet, and e-mail, but the EDI documents themselves still remain.

As more trading partners use the Internet for transmission, standards have emerged. In 2002, the IETF published RFC 3335, offering a standardized, secure method of transferring EDI data via e-mail. On Jul. 12, 2005, an IETF working group ratified RFC4130 for MIME-based HTTP EDIINT AS2) transfers, and is preparing a similar RFC for FTP transfers AS3). While some EDI transmission has moved to these newer protocols, the providers of the value-added networks remain active.

EDI documents generally contain the same data that would normally be found in a paper document used for the same organizational function. For example an EDI 940 ship-from-warehouse order is used by a manufacturer to tell a warehouse to ship product to a retailer. It typically has a ship to address, bill to address, a list of product numbers (usually a UPC) and quantities. Another example is the set of messages between sellers and buyers, such as request for quotation (RFQ), bid in response to RFQ, purchase order, purchase order acknowledgment, shipping notice, receiving advice, invoice, and payment advice. However, EDI is not confined to just business data related to trade but encompasses all fields such as medicine (e.g., patient records and laboratory results), transport (e.g., container and modal data), engineering and construction, etc. In some cases, EDI may be used to create a new business data flow (that was not a paper flow before). a person's is the case in the Advanced Shipment Notification (856) which was designed to inform the receiver of a shipment, the goods to be received and how the goods are packaged.

Some major sets of EDI standards include:
1. The United Nations recommended UN/EDIFACT is the only international standard and is predominant outside of North America
2. The US standard ANSI ASC X12 (X12) is predominant in North America.
3. The TRADACOMS standard developed by the ANA (Article Numbering Association) is predominant in the UK retail industry.
4. The ODETTE standard used within the European automotive industry

All of these standards first appeared in the early to mid 1980s. The standards prescribe the formats, character sets, and data elements used in the exchange of business documents and forms. The complete X12 Document List includes all major business documents, including purchase orders (called “ORDERS” in UN/EDIFACT and an “850” in X12) and invoices (called “INVOIC” in UN/EDIFACT and an “810” in X12).

The EDI standard indicates which pieces of data are mandatory for a particular document, which pieces are optional and give the rules for the structure of the document. The standards are like building codes. Two EDI documents can follow the same standard and contain different sets of data. For example a food company may indicate a product's expiration date while a clothing manufacturer would choose to send color and size data.

There are many benefits of traditional cellular manufacturing for a company if applied correctly, part movement, set-up time, and wait time between operations are typically reduced, resulting in a reduction of work in progress inventory freeing idle capital that can be better utilized elsewhere. Traditional cellular manufacturing, in combination with the other lean manufacturing and just-in-time processes, also helps eliminate overproduction by only producing items when they are needed. The results are cost savings and the better control of operations.

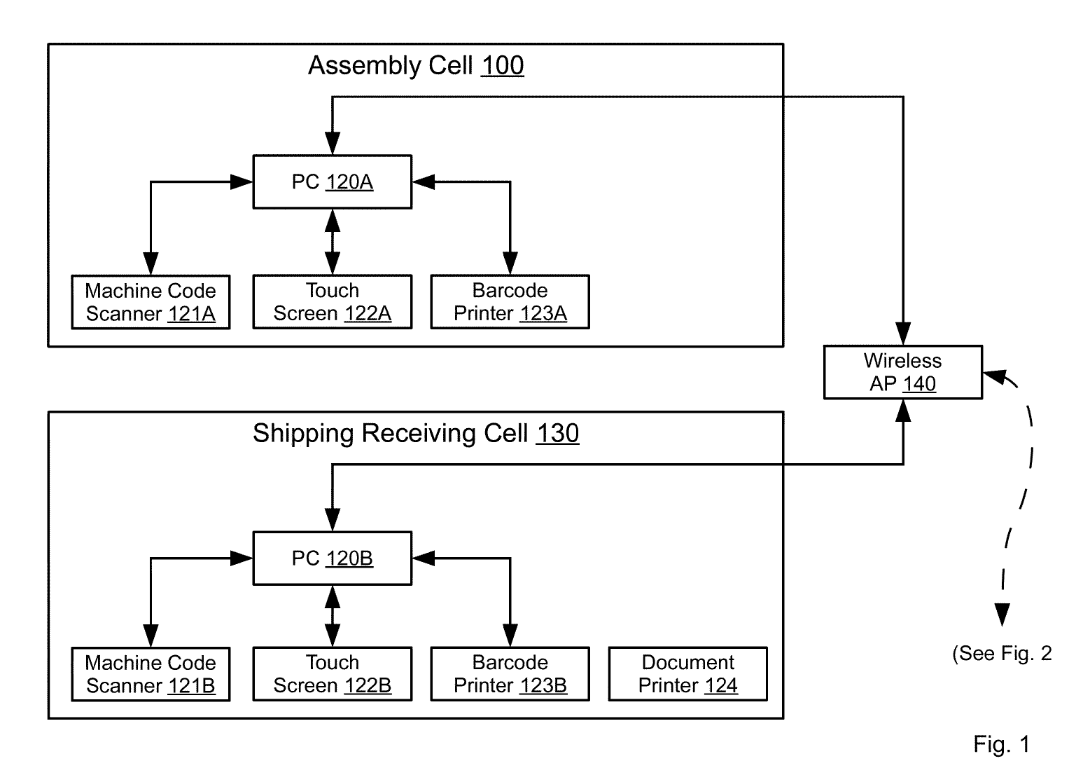

FIG. 1 is an illustration of the computer implemented work cells used in the present invention's advanced cell manufacturing innovation.

Assembly Cell 100 includes a work bench (not shown), parts racks (not shown), tools (not shown), and various computer implemented hardware/software. Computer implemented hardware includes PC 120A, Machine Code Scanner 121A, Touch Screen 122A, and Barcode Printer 123A.

PC 120A is any general-purpose computer whose size, capabilities, and original sales price make it useful for individuals, and which is intended to be operated directly by an end-user with no intervening computer operator.

Machine Code Scanner 121A, is usually a barcode scanner within the present invention, but may be a Radio Frequency Identification Scanner (RFID), or other type of machine readable code scanner. Implemented as a barcode scanner, Machine Code Scanner 121A is an electronic device for reading printed barcodes. It consists of a light source, a lens and a light sensor translating optical impulses into electrical ones. Additionally, nearly all barcode readers contain decoder circuitry analyzing the barcode's image data provided by the sensor and sending the barcode's content to the scanner's output port.

Touch Screen 122A is an electronic visual display that can detect the presence and location of a touch within the display area. The term generally refers to touching the display of the device with a finger or hand. Touchscreens can also sense other passive objects, such as a stylus.

Touch screens have two main attributes. First, it enables a user to interact directly with what is displayed, rather than indirectly with a pointer controlled by a mouse or touch-pad. Secondly, it lets a user do so without requiring any intermediate device that would need to be held in the hand. Such displays can be attached to computers, or to networks as terminals.

Barcode Printer 123A is a computer peripheral for printing barcode labels or tags that can be attached to physical objects. Barcode printers are commonly used to label cartons before shipment, or to label retail items with UPCs or EANs.

The most common barcode printers employ one of two different printing technologies. Direct thermal printers use a print-head to generate heat that causes a chemical reaction in specially designed paper that turns the paper black. Thermal transfer printers also use heat, but instead of reacting the paper, the heat melts a waxy or resin substance on a ribbon that runs over the label or tag material. The heat transfers ink from the ribbon to the paper. Direct thermal printers are generally less expensive, but they produce labels that can become illegible if exposed to heat, direct sunlight, or chemical vapors.

Machine Code Scanner 121A, Touch Screen 122A, and Barcode Printer 123A are connected to ports (not shown) on PC 120A.

PC 120A is connected wireless to Wireless AP (Access Point) 140. Wireless AP 140 is a device that allows wireless devices to connect to a wired network using Wi-Fi, Bluetooth or related standards. The WAP usually connects to a router (via a wired network), and can relay data between the wireless devices (such as computers or printers) and wired devices on the network

Throughout the present invention, communication links are the means of connecting one location to another for the purpose of transmitting and receiving analog or digital information. There are at least three types of basic data-link configurations that can be conceived of and used:
1. Simplex communications, most commonly meaning all communications in one direction only.
2. Half-duplex communications, meaning communications in both directions, but not both ways simultaneously.
3. Duplex communications, communications in both directions simultaneously.

Shipping Receiving Cell 130 includes a work bench (not shown), parts racks (not shown), tools (not shown), and various computer implemented hardware/software.

An option of the present invention is to provide for the use of an encapsulated HomePlug communication system protocol over a wired communication system.

An option of the present invention is to provide for the use of an encapsulated modem standard protocol such as, but not limited to Modem 110 baud, Modem 300 baud (V.21), Modem Bell 103 (Bell 103), Modem 1200 (V.22), Modem Bell 212A (Bell 212A), Modem 2400 (V.22bis), Modem 9600 (V.32), Modem 14.4 k (V.32bis), Modem 19.2 k (V.32terbo), Modem 28.8 k (V.34), Modem 33.6 k (V.34plus/V.34bis), Modem 56k (V.90), and Modem 56k (V.92) over a wire communication system.

An option of the present invention is to provide for the use of an encapsulated Integrated Services Digital Network (ISDN) based communication system protocol, such as, but not limited to 64k ISDN and 128k dual-channel ISDN over a wire communication system.

An option of the present invention is to provide for the use of an encapsulated computer interface protocol, such as, but not limited to Serial RS-232, Serial RS-232 max, USB Low Speed, Parallel (Centronics), Serial RS-422 max, USB Full Speed, SCSI 1, Fast SCSI 2, FireWire (IEEE 1394) 100, Fast Wide SCSI 2, FireWire (IEEE 1394) 200, Ultra DMAATA 33, Ultra Wide SCSI 40, FireWire (IEEE 1394) 400, USB Hi-Speed, Ultra DMAATA 66, Ultra-2 SCSI 80, FireWire (IEEE 1394b) 800, Ultra DMAATA 100 800, Ultra DMA ATA 133, PCI 32/33, Serial ATA (SATA-150), Ultra-3 SCSI 160, Fibre Channel, PCI 64/33, PCI 32/66, AGP 1x, Serial ATA (SATA-300), Ultra-320 SCSI, PCI Express (x1 link), AGP 2×, PCI 64/66, Ultra-640 SCSI, AGP 4×, PCI-X 133, InfiniBand, PCI Express (x4 link), AGP 8×, PCI-X DDR, HyperTransport (800 MHz, 16-pair), PCI Express (x16 link), iSCSI (Internet SCSI), and HyperTransport (1 GHz, 16-pair) over a wire communications system.

An option of the present invention is to provide for the use of an encapsulated wireless communication based on standard protocols such as, but not limited to IrDA-Control, 802.15.4 (2.4 GHz), Bluetooth 1.1, 802.11 legacy, Bluetooth 2, RONJA free source optical wireless, 802.11b DSSS, 802.11b+non-standard DSSS, 802.11a, 802.11g DSSS, 802.11n, 802.16 (WiBro) and 802.16 (Hiperman) over a wire communications system.

An option of the present invention is to provide for the use of an encapsulated mobile telephone standards protocol, such as, but not limited to, GSM CSD, HSCSD, GPRS, and UMTS over a wire communications system.

An option of the present invention is to provide for the use of an encapsulated wide area network based system protocol, such as but not limited to, DS0, Satellite Internet, Frame Relay, G.SHDSL, SDSL, ADSL, ADSL2, ADSL2Plus, DOCSIS (Cable Modem), DS1/T1, E1, E2, E3, DS3/T3, OC1, VDSL, VDSL, VDSL2., OC3, OC12, OC48, OC192, 10 Gigabit Ethernet WAN PHY, 10 Gigabit Ethernet LAN PHY, OC256, and OC768 over a wire communications system.

An option of the present invention is to provide for the use of an encapsulated local area network protocol such as, but not limited to, LocalTalk, ARCNET, Token Ring, Ethernet (10 base-X), Fast Ethernet (100 base-X), FDDI, and Gigabit Ethernet (1000 base-X) over a wire communications system.

An option of the present invention is to provide for the use of an encapsulated VoIP (Voice over IP) standard signaling protocols, such as, but not limited to, H.323, Megaco H.248 Gateway Control Protocol, MGCP Media Gateway Control Protocol, RVP over IP Remote Voice Protocol Over IP Specification, SAPv2 Session Announcement Protocol SGCP, Simple Gateway Control Protocol, SIP Session Initiation Protocol, and Skinny-Skinny Client Control Protocol (Cisco) over a wire communications system.

An option of the present invention is to provide for the use of an encapsulated VoIP (Voice over IP) standard media protocols, such as, but not limited to, DVB Digital Video Broadcasting, H.261 Video stream for transport using the real-time transport, H.263 Bitstream in the Real-time Transport Protocol, RTCP RTP Control protocol, and RTP Real-Time Transport over a wire communications system.

An option of the present invention is to provide for the use of encapsulated VoIP (Voice over IP) H.323 suite of standard protocols, such as, but not limited to, H.225 Covers narrow-band visual telephone services, H.225 Annex G H.225E H.235 Security and authentication H.323SET H.245 Negotiates channel usage and capabilities, H.450.1 Series defines Supplementary Services for H.323, H.450.2 Call Transfer supplementary service for H.323, H.450.3 Call diversion supplementary service for H.323, H.450.4 Call Hold supplementary service, H.450.5 Call Park supplementary service, H.450.6 Call Waiting supplementary service, H.450.7 Message Waiting Indication supplementary service, H.450.8 Calling Party Name Presentation supplementary service, H.450.9 Completion of Calls to Busy Subscribers supplementary service, H.450.10 Call Offer supplementary service, H.450.11 Call Intrusion supplementary service, H.450.12 ANF-CMN supplementary service, RAS Manages registration, admission, status, T.38 IP-based fax service maps, T.125 Multipoint Communication Service Protocol (MCS) over a wire communications system.

An option of the present invention is to provide for the use of encapsulated VoIP (Voice over IP) SIP suite of standard protocols, such as, but not limited to, MIME, SDP Session Description Protocol, and SIP Session Initiation Protocol over a wire communications system.

Referring to FIG. 1, computer implemented hardware for the Shipping Receiving Cell 130 includes PC 120B, Machine Code Scanner 121B, Touch Screen 122B, Barcode Printer 123B, and Document Printer 124.

PC 120B is any general-purpose computer whose size, capabilities, and original sales price make it useful for individuals, and which is intended to be operated directly by an end-user with no intervening computer operator.

Machine Code Scanner 121B, is usually a barcode scanner within the present invention, but may be a Radio Frequency Identification Scanner (RFID), or other type of machine readable code scanner. Implemented as a barcode scanner, Machine Code Scanner 121B is an electronic device for reading printed barcodes. It consists of a light source, a lens and a light sensor translating optical impulses into electrical ones. Additionally, nearly all barcode readers contain decoder circuitry analyzing the barcode's image data provided by the sensor and sending the barcode's content to the scanner's output port.

Touch Screen 122B is an electronic visual display that can detect the presence and location of a touch within the display area. The term generally refers to touching the display of the device with a finger or hand. Touchscreens can also sense other passive objects, such as a stylus.

Touch screens have two main attributes. First, it enables a user to interact directly with what is displayed, rather than indirectly with a pointer controlled by a mouse or touch-pad. Secondly, it lets a user do so without requiring any intermediate device that would need to be held in the hand. Such displays can be attached to computers, or to networks as terminals.

Barcode Printer 123A is a computer peripheral for printing barcode labels or tags that can be attached to physical objects. Barcode printers are commonly used to label cartons before shipment, or to label retail items with UPCs or EANs.

The most common barcode printers employ one of two different printing technologies. Direct thermal printers use a print-head to generate heat that causes a chemical reaction in specially designed paper that turns the paper black. Thermal transfer printers also use heat, but instead of reacting the paper, the heat melts a waxy or resin substance on a ribbon that runs over the label or tag material. The heat transfers ink from the ribbon to the paper. Direct thermal printers are generally less expensive, but they produce labels that can become illegible if exposed to heat, direct sunlight, or chemical vapors.

Document Printer 124 is a peripheral which produces a text or graphics of documents stored in electronic form, usually on physical print media such as paper or transparencies. Many printers are primarily used as local peripherals, and are attached by a printer cable or, in most new printers, a USB cable to a computer which serves as a document source. Some printers, commonly known as network printers, have built-in network interfaces, typically wireless or Ethernet based, and can serve as a hard copy device for any user on the network. Individual printers are often designed to support both local and network connected users at the same time. In addition, a few modern printers can directly interface to electronic media such as memory cards, or to image capture devices such as digital cameras and scanners; some printers are combined with scanners or fax machines in a single unit, and can function as photocopiers. Printers that include non-printing features are sometimes called multifunction printers (MFP), multi-function devices (MFD), or all-in-one (AIO) printers. Most MFPs include printing, scanning, and copying among their many features.

Machine Code Scanner 121B, Touch Screen 122B, Barcode Printer 123B, and Document Printer 124 are connected to ports (not shown) on PC 120B.

PC 120B is connected wireless to Wireless AP (Access Point) 140. Wireless AP 140 is a device that allows wireless devices to connect to a wired network using Wi-Fi, Bluetooth or related standards. The WAP usually connects to a router (via a wired network), and can relay data between the wireless devices (such as computers or printers) and wired devices on the network.

Optionally, PC 120A and Touch Screen 122A can be replaced by a tablet computer (Not Shown). A tablet computer is a one-piece mobile computer. These devices typically offer a touchscreen, with finger, or stylus, gestures as the primary means of control, which are often supplemented by the use of one or more physical context sensitive buttons or the input from one or more accelerometers. Typically, an on-screen, hideable virtual keyboard is usually offered as the principal means of data input. Tablet computers are available in a variety of sizes, tablets customarily offer a screen diagonal greater than 7″, which differentiates them through size from functionally similar smart phones or personal digital assistants.

Though generally self-contained a tablet computer may optionally be connected to a physical keyboard, or other input device, and a number of Hybrids that offer a detachable keyboard. Tablet computers also appear in a foldable booklet format that offer the user dual-touchscreens, and can be used as a notebook by displaying a virtual keyboard on one of the displays.

Optionally, PC 120B and Touch Screen 122B can be replaced by a tablet computer (Not Shown). A tablet computer is a one-piece mobile computer. These devices typically offer a touchscreen, with finger, or stylus, gestures as the primary means of control, which are often supplemented by the use of one or more physical context sensitive buttons or the input from one or more accelerometers. Typically, an on-screen, hideable virtual keyboard is usually offered as the principal means of data input. Tablet computers are available in a variety of sizes, tablets customarily offer a screen diagonal greater than 7″, which differentiates them through size from functionally similar smart phones or personal digital assistants.

Though generally self-contained a tablet computer may optionally be connected to a physical keyboard, or other input device, and a number of Hybrids that offer a detachable keyboard. Tablet computers also appear in a foldable booklet format that offer the user dual-touchscreens, and can be used as a notebook by displaying a virtual keyboard on one of the displays.

Assembly Cell 100 can also be re-purposed to serve as a Kitting Cell, where rolling racks (not shown) can be pre-loaded with Kanbans of components necessary to supply at least one Assembly Cell 100 with parts. The Kanbans on the rolling racks provide visual controls to keep the at least one Assembly Cell 100 operating at the highest efficiency.

Assembly Cell 100 and Shipping Receiving Cell 130 are modular workbenches (not shown), and include self-contained lighting (not shown), an overhead trolley (not shown) for keeping battery operated tools (not shown) ready for use in close proximity, power strips (not shown) for plugging in devices that required electricity, shelves (not shown) for holding barcode readers or various types of printers, drawers (not shown) with foam cutouts (not shown) for tooling (not shown) required to assemble a specific product, can be outfitted with table tops (not shown) made of a material that is appropriate for the product being assembled. Such optional table top materials include, but are not limited to, plastic laminate, stainless steel, pressed wood, hardwood, laminated wood, phenolic resin, anti-static electrostatic discharge (ESD), etc.

In addition Assembly Cell 100, and Shipping Receiving Cell 130 also include anti-fatigue mats (not shown) to reduce worker fatigue.

PC 120A, 120B operating in conjunction respectively with Touch Screen 122A, 122B, or alternatively a Table Computer (not shown) that replaces PC 120A, 120B operating in conjunction respectively with Touch Screen 120A, 120B use an integrated information technology software suite.

This integrated information technology software suite is built on an off-the-shelf Enterprise Resource Planning (ERP) software's supply chain and manufacturing fulfillment logic, which is modified extensibly to include integrated business modules for projects (orders) from pre-sales, to sales, to customer premise audits, to sales engineering activities, and also through the project management cycle of all field activities. In other-words, the underlying ERP supply chain management system is modified to include non-supply chain management activities that occur before and after the primary manufacturing fulfillment modules that comprise standard ERP logic and processes, such as, procurement, route sheets, etc.

The ISO 9001/OSHA Rules-Based business and process logic is programmed into control layer web screens, and the underlying ERP/Project Management system feed an intermediate series of databases, which in turn feed the ISO 9001/OSHA Rules-Based business logic and process screens. In this way, ERP systems can easily be substituted if the need arises. The ISO 9001/OSHA Rules-Based control layer also includes log-on, VPN controls, time-clock, tasks, messaging, and other functions for all users of the system.

The ISO 9001/OSHA Rules-Based control layers are driven by projects (orders), and dashboards to give account executives, management personnel, engineering, and project managers quick visual representations of work that needs to be completed in order to drive a specific project (order) through the system from pre-sales to procurement to manufacturing to installation by a qualified contractor to custody, control, and disposal of old product and to follow-up validation.

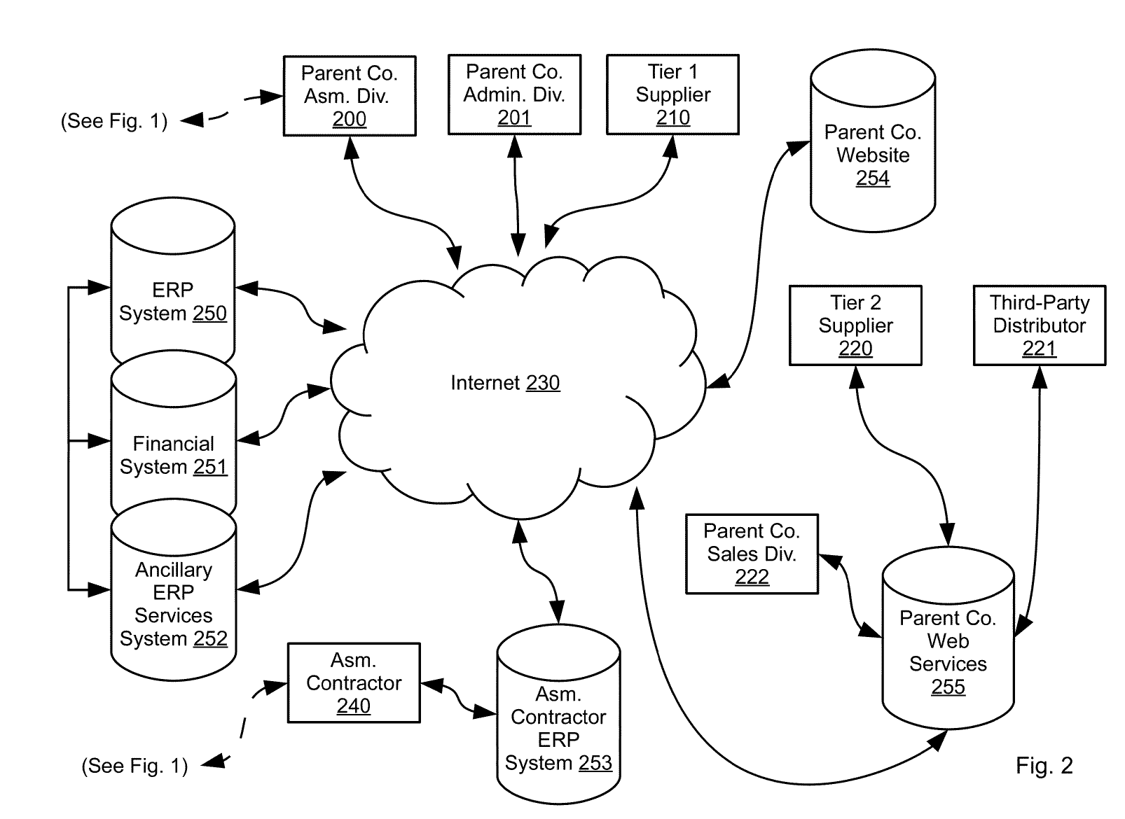

FIG. 2 is an illustration of the high level network architecture of the hardware/software used in the advanced cell manufacturing process innovation of the present invention.

Internet 230 is a global system of interconnected computer networks that use the standard Internet protocol suite (often called TCP/IP, although not all protocols use TCP) to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support email.

Parent Co. Asm. Div. 200 is a wholly-owned subsidiary of the parent company that performs captive, cell-based manufacturing and/or assembly operations. Parent Co. Asm. Div. 200 is comprised of floor space for cell-based operations, warehousing, and offices. At least one of each of the work cells illustrated in FIG. 1 are included in Parent Co. Asm. Div. 200. Said work cells illustrated in FIG. 1 are connected via a wired or wireless connection to Internet 230 via VPN (Virtual Private Network) to ERP System 250, Financial System 251, Ancillary ERP Services Systems 252, and Parent Co. Web Services 255.

All network connections illustrated in FIG. 2 are typically on a VPN. Said VPN is a network that uses primarily public telecommunication infrastructures, such as the Internet, to provide remote offices or traveling users an access to a central organizational network.

VPN connections typically require remote users of the network to be authenticated, and often secure data with encryption technologies to prevent disclosure of private information to unauthorized parties.

VPNs may serve any network functionality that is found on any network, such as sharing of data and access to network resources, printers, databases, websites, etc. A VPN user typically experiences the central network in a manner that is identical to being connected directly to the central network. VPN technology via the public Internet has replaced the need to requisition and maintain expensive dedicated leased-line telecommunication circuits once typical in wide-area network installations.

VPN reduces costs because it does not need physical leased lines to connect remote users to an intranet.

Parent Co. Admin. Div. 201 is responsible for administering high level management of ISO 9001 Quality Systems, including quality manuals, procedures, and work instructions. In addition, Parent Co. Admin. Div. 201 is responsible for centralized product engineering, centralized industrial engineering, centralized purchasing, centralized materials management, and centralized customer service. Parent Co. Admin. Div. 201 is shown connected via a wired or wireless connection to Internet 230 via VPN (Virtual Private Network) to remotely located systems including, ERP System 250, Financial System 251, Ancillary ERP Services Systems 252, and Parent Co. Web Services 255.

Alternatively, ERP System 250, Financial System 251, Ancillary ERP Services Systems 252, and Parent Co. Web Services 255 may be co-located within Parent Co. Admin. Div. 201.

Tier 1 Supplier 210 is a semi-captive operation, such as a joint-venture, that is responsible for supplying parts and/or sub-assemblies and/or finished goods. Tier 1 Supplier 120 may be co-located with Parent Co. Admin. Div. 201, or located remotely. Tier 1 Supplier 120 is connected via a wired or wireless connection to Internet 230 via VPN (Virtual Private Network) to ERP System 250, Financial System 251, Ancillary ERP Services Systems 252, and Parent Co. Web Services 255. Alternatively, Tier 1 Supplier 210 may be running a local instance of the ERP System (not shown), which is connected via Internet 230 to the master ERP System 250.

ERP System 250 is the master ERP instance as illustrated in FIG. 2. Enterprise resource planning (ERP) systems integrate internal and external management information across an entire organization, embracing finance/accounting, manufacturing, sales and service, customer relationship management, etc. ERP systems automate this activity with an integrated software application. Their purpose is to facilitate the flow of information between all business functions inside the boundaries of the organization and manage the connections to outside stakeholders.

ERP systems can run on a variety of computer hardware and network configurations, typically employing a database as a repository for information.

Financial System 251 is application software that is to record and process accounting transactions within functional modules such as accounts payable, accounts receivable, payroll, and trial balance. It functions as an accounting information system. It may be developed in-house by the company or organization using it, may be purchased from a third party, or may be a combination of a third-party application software package with local modifications. Financial System 251 and ERP System 250 are stand-alone systems that are integrated with custom middle-ware.

Ancillary ERP Services System 252 is a proprietary software system designed to provide a platform for data collection from the work cells illustrated in FIG. 1, and also provide a platform for tightly integrating ISO 9001 Quality Systems, including, procedures, work instructions, forms, etc. with ERP System 250 with proprietary middle-ware. Touch Screen 122A, 122B displays ERP System 250 information such as, Bills of Material, Work Orders, etc., and related Ancillary ERP Services System 252 information such as, ISO 9001 Work Instructions via words and/or video, etc.

Asm. Contractor 240 operates under contract to Parent Co. Admin. Div. 201 to assemble products.

Asm. Contractor 240 has their own slave instance of ERP System 250, which is Asm. Contractor ERP System 253. Asm. Contractor ERP System 253 shares information such as, inventory with ERP System 250, but Asm. Contractor 240 uses Asm. Contractor ERP System 253 to set parts inventory float levels, assign work orders to various Assembly Cell 100s (as illustrated in FIG. 1), etc.

Parent Co. Website 254 is the public electronic face of the organization.

Tier 2 Supplier 220 interfaces with Parent Co. Admin. Div. 201 through Parent Co.

Web Services 255. The Tier 2 Supplier 220 may be supplying parts and sub-assemblies related to products. Alternatively, they may be supplying office supplies, or MRO supplies to any stakeholder illustrated in FIG. 2.

Third-Party Distributor 221 is a contracted sales/distribution organization for the Parent Co. Admin. Div. 201's products. Third-Party Distributor 221 communicates with the Parent Co. Admin. Div. via Parent Co. Web Services 255.

Parent Co. Sales Div. 222 is a wholly-owned subsidiary, or joint-venture of Parent Co. Admin. Div. 201. interfaces with Parent Co. Admin. Div. 201 through Parent Co. Web Services 255.

Parent Co. Web Services 255 is a software system designed as a firewall, and to support interoperable machine-to-machine interaction over a network. It has an interface described in a machine-processable format (specifically Web Services Description Language, known by the acronym WSDL). Other systems interact with the Web service in a manner prescribed by its description using SOAP messages, typically conveyed using HTTP with an XML serialization in conjunction with other Web-related standards.

### Real World Example of the Present Invention

The Parent Co. Sales Div. 222 generates a sale, and promptly reports it to the Parent Co. Web Services 255 database. The sale is reported using an icon on a touch screen connected to a laptop or PC, or a mobile phone, or alternatively using a traditional laptop or PC screen to access the icon via keyboard stokes and mouse movements. The icon opens up a VPN connection automatically, and validates the connection automatically, and makes a hyperlink to a URL automatically to the URL of the Parent Co. Web Services 255 database and software application to complete the sales order input. The Parent Co. Web Services 255 acts as a firewall to protect the sensitive and confidential information contained within the ERP System 250, Financial System 251, and the Ancillary ERP Services System 252 databases. The Parent Co. Web Services can be operating in the cloud, or on a wholly-owned server, or leased server.

Customer Sales at the Parent Co. Admin. Div. 201 uses an icon on their laptop or desktop to generate a list of incoming sales orders for review, and completes the sales order for payment terms, due date, etc., and enters it into the ERP System 250 in order to complete the review process and begin the task of moving the sales order through the physical and computer implemented system in order to produce a product, which may include the need to source parts needed to complete the order from vendors, or from stock, and to create a work order(s) to produce the final product SKU complete with an anticipated due date FOB the assembly facility, and finally to arrange for all needed certificates, warranties, and shipping papers for each sales order to be complete. These tasks may require a materials manager, purchasing agent, and production manager's involvement at the Parent Co. Admin. Div. 201.

When all the parts have been aggregated within either a wholly-owned, or contracted assembly organization, the ERP System 250 generates at least one work order of at least a quantity of one for at least one assembly cell to complete the sales order. The Kitter(s) working in the assembly divisions use a touch screen icon to access the Ancillary ERP Systems Service 252 database which is in communication with the ERP System 250. The icon automatically connect them via VPN connection to the Ancillary ERP Services System 252 which provides them kitting work orders several hours in advance of when they are needed at a particular assembly work cell. Once the kitter has completed a work order, an icon on the touch screen at their station is used to invoke a reporting function back to the Ancillary ERP Services System 252 database, which is in constant communication with the master ERP System 250 instance.

The assembly work cell uses Kanbans to report to the kitters where their stock levels are for individual part SKUs which are housed in different colored bins for different individual part SKUs.

The assembly cell workers use touch screen icons on 122A, 122B to launch an app that generates a work order of at least one for the next specific product. The assembly cell working in their end-to-end manufacturing/assembly environment has icon driven access to apps for ISO work instructions in word and/or visual and/or audio formats to guide them through an assembly process, as needed. The ISO work instructions in text and/or visual and/or audio formats may be XML driven for maximum language flexibility. In addition, the ISO work instructions available via touch screen icons are in complete sync with the ERP System 250's revision levels for part level vs. corresponding tooling revision level vs. any specialized requirements for custom labeling, custom packaging, etc.

The material handling workers respond visually to requests to move completed goods, which have been palletized and wrapped for shipment to be picked-up and staged or stored within the warehouse environment.

The shipping/receiving workers use touch screen icons at their unique work stations described in FIG. 2 to collate shipments, generate manifests, shipping papers, manifests, etc., and report their work to the Ancillary ERP Services System 252 database, which is in constant communication with the master instance of ERP System 250 instance. The shipping/receiving worker can use touch screen icons at their unique work stations described in FIG. 2 to receive goods and parts into inventory, and to report damaged goods and parts into QA holding, etc. The shipping/receiving worker has a wireless machine code scanner that is capable of scanning barcodes, as well as interfacing with the Ancillary ERP Services System 252 via icons on the machine code scanner screen operating a browser.

Once a work order is completed, ERP System 250 communicates with Financial System 251, which can be used by controllers and production managers at assembly division, or the administration division for generating financial reports.

An Assembly Contractor 240 would follow the same basic process as outline above, but they would be reporting to a local instance of the ERP System, Asm. Contractor ERP System 253. The local instance reports parts, finished goods, shipments to the master ERP instance, ERP System 250. The local instance of the ERP system would be used to generate work orders, float levels, etc., at the Asm. Contractor's control. It is the Ancillary ERP Services System 252 would be local and remote, and it is the concatenation point of all icon driven requests into the total IT management control system. The local portion of the Ancillary ERP Services System 252 intranet, would provide services for driving icons for collecting data from the assembly cells, and the shipping/receiving cells, but the remote portion of the Ancillary ERP Services System 252 is an extranet, and used for providing high-level, high-level of controlled documents for ISO Quality Manuals, ISO Procedures, and ISO Work Instructions in word and/or visual and/or audio format.

As much as possible throughout the system, may be used as a means of translating data, transporting data, and also a lexicon for data meaning The XML lexicons can be standard, or proprietary. In addition, due to the browser based nature of the ERP System 250 and the Ancillary ERP Services System 252, the use of open standards such as Google's protocol buffers can be employed, for instance if an app is built that uses Google Earth geographically based information.

The present invention has been described in particular detail with respect to several possible embodiments. Those of skill in the art will appreciate that the invention may be practiced in other embodiments. First, the particular naming of the components and capitalization of terms is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage devices. Certain aspects of the present invention include process steps and instructions. It should be noted that the process steps and instructions of the present invention could be embodied in software, firmware or hardware, and when embodied in software, could be downloaded to reside on and be operated from different platforms. Furthermore, the computers referred to in the specification may include a single processor or may be architectures employing multiple processor designs for increased computing capability.

The scope of this invention should be determined by the appended claims and their legal equivalents, rather than by the examples given.

What is claimed is:

1. A method for assembling LED products, the method comprising:
a. Leveraging low burden rates per hour per spare foot at a location;
b. Creating a lean environment for workers at the location;
c. Creating a manufacturing cell, the cell including all parts of the LED product and wherein all parts of the LED product are ordered from vendors and wherein the vendors package the parts in pre-matched quantities;
d. Wherein a single user assembles the LED product in the manufacturing cell; and
e. Wherein the assembly of the LED product takes place in a geographical proximity to the end user.

2. The method of claim 1 further comprising a plurality of manufacturing cells which are geographically distributed based on end user location.

3. The method of claim 1 wherein more than one type of LED product is assembled in the same manufacturing cell.

4. The method of claim 1 wherein each worker assembles a complete LED product.

5. The method of claim 1 wherein a plurality of manufacturing cells are present at the location.

6. The method of claim 1 wherein the LED product is assembled, packaged and labeled within a single cell.

7. The method of claim 1 further comprising reporting the completion of the LED product within the cell.

8. The method of claim 1 wherein the manufacturing cell is located at the end user location.

9. The method of claim 1 further comprising using a just in time delivery protocol.

10. A system for use in assembling LED products, the system comprising:
a. An information technology manufacturing management system which organizes work orders according to sales;
b. A parts supply system which delivers components for a single LED product as a kit
c. A manufacturing cell wherein the cell is provided with one or more kits; and
d. Wherein a single user in the cell completes assembly, packaging, labeling and reporting of the LED product from the components in the kit.

11. The system of claim 10 further comprising a computer with a touchscreen interface in the manufacturing cell.

12. The system of claim 10 further comprising a kitting cell.

13. The system of claim 12 wherein the kitting cell includes a plurality of components for LED products.

14. The system of claim 10 further comprising an enterprise resource planning system to integrate internal and external management information.

15. The system of claim 10 wherein the enterprise resource planning system is operatively connected to the computer through a VPN connection.

16. A manufacturing cell, the manufacturing cell comprising:
a. A workspace for a single user;
b. A plurality of kits, the kits including components for the assembly of an LED product;
c. A computer with a touch screen interface, the computer operatively connected to the internet;
d. A printer operatively connected to the computer;
e. A machine code scanner operatively connected to the computer;

17. The manufacturing cell of claim 16 wherein the computer is a handheld device.

18. The manufacturing cell of claim 16 wherein the machine code scanner is a bar code reader.

19. The manufacturing cell of claim 16 wherein the computer is connected to the internet through a wireless access point.

20. The manufacturing cell of claim 16 wherein the computer is a tablet.
